(19) United States
(12) Patent Application Publication
(10) Pub. No.: US 2003/0108109 A1
(43) Pub. Date: Jun. 12, 2003

(54) Routing miller factor cancelling technique

(76) Inventors: Cong Q. Khieu, San Jose, CA (US); Zhigang Han, Pasadena, CA (US)

Correspondence Address: CAMPBELL STEPHENSON ASCOLESE, LLP, 4807 SPICEWOOD SPRINGS RD., BLDG. 4, SUITE 201, AUSTIN, TX, 78759, US

(21) Appl. No.: 10/014,301

(22) Filed: Dec. 10, 2001

(51) Int. Cl. H04B 3/00; H04L 25/00

(52) U.S. Cl. 375/257

(57) ABSTRACT

A method and system for reducing coupling capacitance interference between adjacent transmission lines in an electrical circuit. The method and system includes the use of inverter and buffer devices that are laid out along signal paths carrying signal transmissions to assure that a portion of signal transmission between devices has zero coupling capacitance, yet provides for a net coupling capacitance of one.

### FIELD OF THE INVENTION

This invention relates to a method and system to reduce or eliminate interference between paths in an electrical network, in particular to an electronic circuit.

### DESCRIPTION OF THE RELATED ART

Electrical networks, in particular electrical networks on integrated circuits (IC) chips, have a number of devices that communicate with one another. Additionally, a number of paths carry signals from device to device. Paths that are placed near one another can lead to problems related to coupling capacitance interference. The situation becomes more problematic when a number of paths carrying signals that switch in the same direction run parallel to a single path carrying a signal switching in the opposite direction.

As circuits become smaller and more integrated as in the case of evolving very large scale integrated (VLSI) circuits, signal paths are required to be place closer to one another. As signal paths are placed closer to one another, the possibility of coupling capacitance interference increases. Interference can result in transmission error, and at the least signal delays. In high-speed circuits, signal delays in critical paths can affect operation of the entire system.

Adjacent signal paths can carry signals having values that oppose one another. In digital systems, paths carrying a voltage value representing a “1” can affect a signal value path transmitting a digital value of “0” and vice versa. This problem is known as coupling interference between signal paths.

A phenomenon known as Miller effect or Miller factor can affect signal transmission of simultaneously switching devices. Miller factor is considered coupling capacitance interference. The Miller factor occurs when voltages at both ends of a capacitor, or when two adjacent devices are close to one another, change (switch) at the same time. The net result is an effectively larger capacitor or stronger device. In digital systems, devices that have signals that switch in the same direction do not have a transmission problem; the effect of an adjacent device to the transmitting device is a stronger signal. When adjacent devices switch opposite one another, an effectively weaker signal is transmitted; the Miller factor can effectively cancel out the signals of the opposite switching devices. In digital systems, devices that have signals that switch in the opposite direction can have transmission problems; signals can be cancelled, or the device can be forced to increase power, leading to delay in transmission.

In circuits having relatively long signal paths, repeater devices can be placed along the paths. Typically repeater devices are placed every four millimeters from the originating signal source device. Repeater devices are used to continue transmission of the originating signal along the paths.

In cases of multiple paths carrying signals that switch opposite of a single path, multiple paths are referred to as aggressors and the single path is referred to as a victim. Coupling capacitance interference does not have a noticeable effect upon aggressor signals with one another, since the signals of the aggressors are switching in the same direction. In a digital signal transmission, the rise of the signal from a driver connected to an aggressor path is not affected by signals from other aggressor paths. Coupling capacitance interference, however, can have an effect upon the victim path's signal. In particular coupling capacitance interference leads to slower rise times of victim path signals and leads to delay in signal transmission. To compensate for slower rise times, victim path driver power is forced to increase. Victim path driver is required to provide additional power to compensate for a slower rise time in order to get the signal out and to achieve proper signal level and timing requirements.

To alleviate the effects on victim paths by aggressor paths, paths can be laid out to allow paths that carry signals that switch in the same direction to be placed near one another. This approach, however, leads to design constraints that require paths to be placed in limited positions and limit network architecture. In most situations, paths have opposing signals placed next to each other (e.g., send and receive signals to and from devices).

To avoid signal interference, in certain designs, neutral paths such as ground paths (also known as shield lines) are available and placed between aggressor and victim paths, effectively shielding the victim path. Shield lines typically serve no function but are merely used to shield the victim path. The use of neutral paths or shield lines also leads to design considerations and network architecture constraints in laying out paths. Adding shield lines further adds to an increase in the space of the network. In an integrated circuit, minimizing size is highly desirable, and adding non-functional shield lines becomes counter productive to meeting the goal of minimizing circuit size.

### SUMMARY OF THE INVENTION

What is needed and is disclosed herein is an invention that provides for a method and a system to minimize or eliminate interference between signal paths, particularly interference related to coupling capacitance interference, by using a combination of signal inverter devices and buffer devices to invert, store, and speed up transmitted signals.

In an embodiment of the invention a signal path is placed near a second signal path where initially the digital signals along the paths have values that are opposite to one another. An inverter device inverts the value of the first signal so that the both signals have the same value and have zero coupling capacitance. The inverted signal later is re-inverted to arrive at a proper value.

In other embodiments of the invention a buffer is used to store and to retransmit or repeat the second signal. The use of the repeater assures that the signal is properly transmitted along the signal path.

In specific embodiments of the invention, buffer and inverter devices are laid out to assure that at least one half of the signal paths which are adjacent to one another have a coupling capacitance interference that is zero.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features and advantages made apparent to those skilled in the art by referencing the accompanying drawings. The use of the same reference number throughout the figures designates a like or similar element.

FIG. 1 is a block diagram illustrating the use of inverters between two intra-IC devices.

FIG. 2 is a block diagram illustrating grouping of buffers and inverters in repeater blocks.

FIG. 3 is a timing diagram illustrating values of signals over a time period from device to device.

While the invention is susceptible to various modifications and alternative forms, specific embodiments thereof are shown by way of example in the drawings and will herein be described in detail, it should be understood, however, that the drawings and detailed description thereto are not intended to limit the invention to the particular form disclosed but on the contrary, the intention is to cover all modifications, equivalents, and alternatives falling within the scope of the present invention as defined by the appended claims.

### DETAILED DESCRIPTION

The following is intended to provide a detailed description of an example of the invention and should not be taken to be limiting of the invention itself. Rather, any number of variations may fall within the scope of the invention which is defined in the claims following the description.

Introduction

The present invention provides a method and system to reduce or eliminate coupling capacitance in electronic circuits. Repeater devices that provide particular buffer or inverter functions are placed along the paths of adjacent signal paths. Buffer type repeater devices (buffer devices) store the transmitted signal, while inverter type repeater devices (inverter devices) invert (flip) the transmitted signal. Buffer devices are placed opposite inverter type repeater device of adjacent signal paths. Since repeater devices are commonly used along the signal paths of very large scale integrated (VLSI) circuits, the use of inverter type and buffer devices does not add to an increase in size of the VLSI circuits.

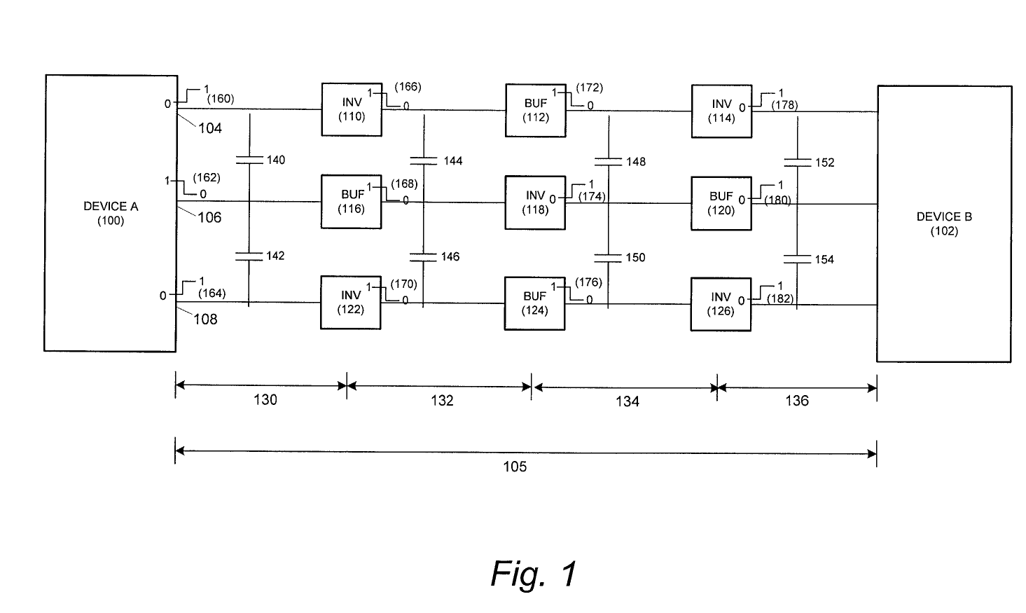

Referring to FIG. 1 a block diagram illustrates the use of inverters between two intra-IC devices. Device A 100 transmits digital signals to device B 102 by way of three signal paths: signal path 104, signal path 106, and signal path 108. Along signal path 104 are inverter device 110, buffer device 112, and inverter device 114.

Along path 106 are buffer device 116, inverter device 118, and buffer device 120. Inverter device 118 can include a buffer. Along path 108 are inverter device 122, buffer device 124, and inverter device 126. Inverter devices 122 and 126 can include buffers as part of the individual devices. Variations of repeater devices can include the use of time delay circuits in devices 110, 112, 114, 116, 118, 120, 122, 124, and 126.

Inverter devices 110, 114, 118, 122, and 126 receive a signal along their respective path, reverse the value of the signal, and retransmit the reversed value along the path. Therefore if a digital equivalent value of “0” is received, the value is reversed to a digital equivalent value of “1” at the output.

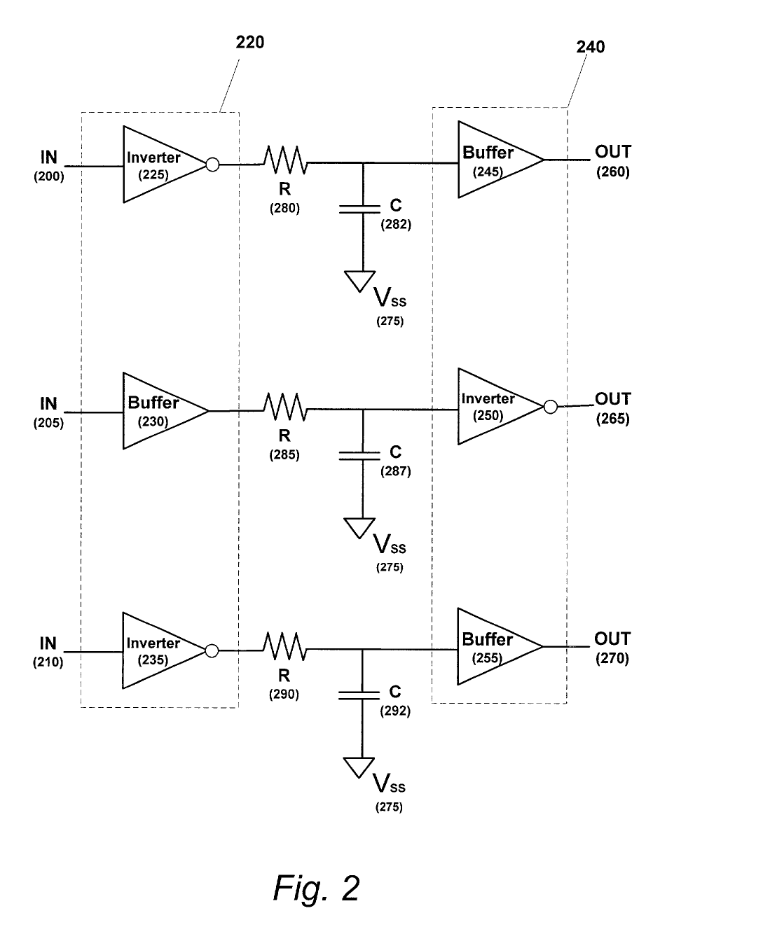

Referring to FIG. 2, a block diagram illustrates grouping of buffers and inverters in repeater blocks. In this particular example, three signals are received by repeater blocks. Inputs of the signals are represented by inputs 200, 205, and 210. Inputs 200, 205, and 210 are received by repeater block 220. Inputs 200, 205, and 210 can be inputs from a device, or inputs received from other repeater blocks along transmission paths. Repeater block 220 includes inverter 225, buffer 230, and inverter 235. Inverter 225 receives input 200. Buffer 230 receives input 205. Inverter 235 receives input 210.

Signals in this example eventually are received by repeater block 240. Repeater block 240 includes buffer 245, inverter 250, and buffer 255. From repeater block 240 are outputs 260, 265, and 270. In particular buffer 245 transmits output 260; inverter 250 transmits output 265; and buffer 255 transmits output 270. Transmitted outputs 260, 265, and 270 are passed on to a device or to another repeater block.

In this particular embodiment, resistor capacitor (RC) time delays are provided. Resistors and capacitors are placed along transmission paths of repeater blocks 220 and 240 and tied to a common ground Vss 275. In particular, resistor 280 is paired with capacitor 282; resistor 285 is paired with capacitor 287; and resistor 290 is paired with capacitor 292.

Capacitors 282, 287, and 292 are charged and discharged, thus affecting transmission of the signal.

Referring back to FIG. 1, signal paths 104, 106, and 108 have length 105 as laid out from device A 100 and device B 102. Inverter 110, buffer device 116, and inverter device 122 are laid out a distance of length 130 from device A 100. In certain embodiments of the invention length 130 is four millimeters. From inverter device 110 to buffer device 112;

buffer device 116 to inverter device 118; and inverter device 122 to buffer device 124, the distance is length 132. In certain embodiments of the invention length 132 is four millimeters. From buffer device 112 to inverter device 114; inverter device 118 to buffer device 120; and buffer device 124 to inverter device 126, the distance is length 134. In certain embodiments of the invention length 134 is four millimeters. Inverter device 114, buffer device 120, and inverter device 126 are laid out a distance of length 136 from device B 102. In certain embodiments of the invention length 136 is four millimeters.

In this embodiment of the invention signal path 106 has one inverter device. When signal paths have an odd number of inverter devices, a receiving device such as device B 102 must have an inverter device that restores the true digital equivalent value as transmitted by a sending device such a as device A 100. Alternatively digital logic in receiving devices can be incorporated to invert received digital equivalent values.

In the described embodiment of the invention, device A 100 is a sender device and device B 105 is a receiver devices. Other embodiments of the invention include devices that send and receive signals to one another. Other embodiments include multiple devices and multiple signal paths; the multiple signal paths connect pairs of devices or connect to different devices. Regardless of how many devices are in a particular system configuration, signal paths can experience coupling capacitance interference from transmission from adjacent signal paths. By laying out buffer devices and inverter devices along signal paths, inverting and delaying signal transitions minimizes the possibility of Miller factor coupling capacitance interference. The slight delay and or inverting of the signal provide for minimal likelihood that signals will switch or transition at the same time. Further since signals over a signal path have both digital equivalent values of “1” or “0, ” coupling interference with adjacent signals occurs over only half of the length of the signal path.

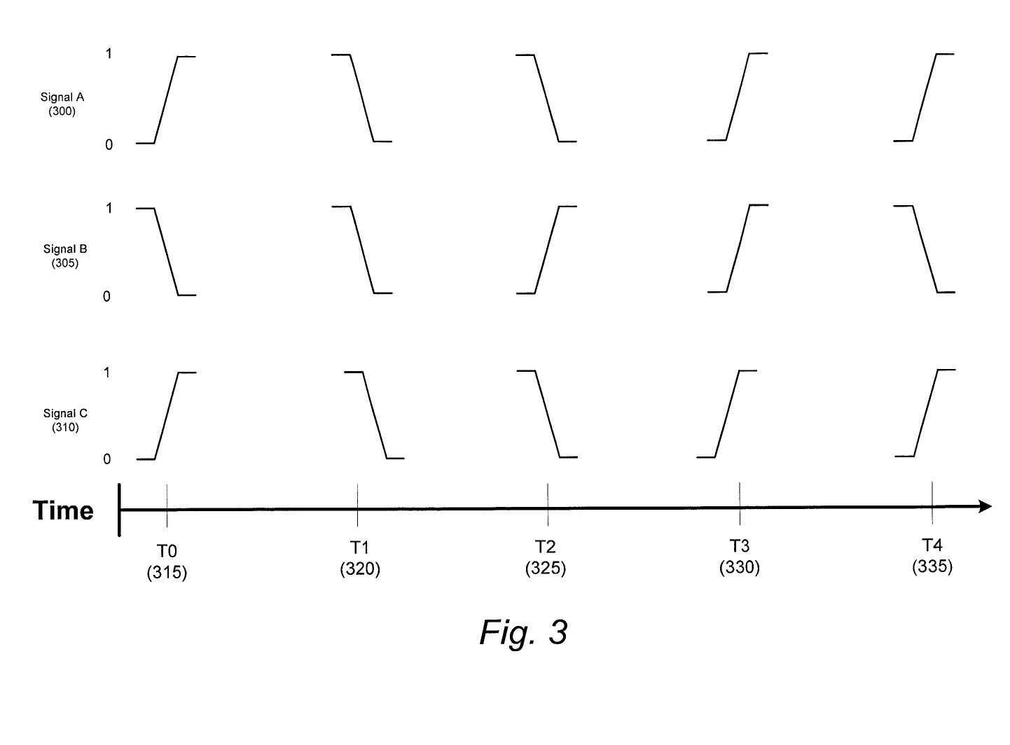

Now referring to FIG. 3 illustrated is a timing diagram illustrating values of signals over a time period from device to device. The timing diagram of FIG. 3 illustrates the values of signals transmitted from device A 100 to device B 102 of FIG. 1 at certain times.

Signal A 300 represents the signal along signal path 104. Signal B 305 represents the signal along signal path 106. Signal C 315 represents the signal along signal path 108. As illustrated signals 300, 305, and 310 can have digital equivalent values of “1” or “0.” Illustrated are transitions from the digital equivalent values of the respective signals.

In this particular example, at time T0 315, device A 100 of FIG. 1 is transmitting signals A 300, B 305, and C 310. Signal A 300 has a value of “1”; signal B 305 has a value of “0”; and signal C has a value of “1.”

At time T1 320, signals A 300, B 305, and C 310 arrive at the first repeater block. The first repeater block includes inverter 110, buffer 116, and inverter 122 of FIG. 1. At time T1 320, and from the first repeater block, signals A 300, B 305, and C 310 have a value of Signals A 300, B 305, and C 310 are passed to a second repeater block that includes buffer 112, inverter 118, and buffer 124 of FIG. 1. At time T2 325, signal A 300 has a value of “0”; signal B 305 has a value of “1”; and signal C 310 has a value of “0.”

Signals A 300, B 305, and C 310 are passed to a third repeater block that includes inverter 114, buffer 120, and inverter 126 of FIG. 1. At time T3 330, signals A 300, B 305, and C 310 have a value of “1.”

Time T4 335 represents the time that signals A 300, B 305, and C 310 are received by device B 102 of FIG. 1. Signal B 305 is inverted at device B 102 and has a value of “0” which represents the original transmitted value of device A 102. At time T4 335, signal A 300 has a value of “1” the original transmitted value of device A 102; and signal C 310 has a value of “1” the original transmitted value of device A 102.

In this particular example, signals 104 and 108 of FIG. 1 act as aggressor signals to signal 106 of FIG. 1, signal 106 is treated as a victim signal. Coupling capacitance interference can be evident up to time T1 320. At time T1 320, signals 300 and 315 are inverted or switched. Since signal 310 retains the same value and is not switched, Miller factor due to switching at time 320 is not present. From time T1 320 to time T2 325, signals 300, 310, and 315 have the same value, therefore coupling interference is not present.

Now referring back to FIG. 1, further description is made as to the use of buffer devices and inverter devices and transmitted signals. In this particular example initial digital signal 160 is transmitted along signal path 104, initial digital signal 162 is transmitted along signal path 106, and initial digital signal 164 is transmitted along signal path 108. Digital signals 160, 162, and 164 are represented by a transition from a digital value of 1 to 0 or a transition from a digital value of 0 to 1. In other words the digital signal 160 is a digital value of 1, digital signal 162 is a digital value of 0, and digital signal 164 is a digital value of 1.

As transmission occurs along the respective signal paths, inverter or buffer devices, either invert the digital signal value or pass along the digital signal value. Inverter device 110 outputs a digital signal 166 with a digital value of 0. Buffer device 116 outputs a digital signal 168 with a digital value of 0. Inverter device 122 outputs a digital signal 170 with a digital value of 0. Buffer device 112 outputs a digital signal 172 with a digital value of 0. Inverter device 118 outputs a digital signal 174 with a digital value of 1. Buffer device 124 outputs a digital signal 176 with a digital value of 0. Inverter device 114 outputs a digital signal 178 with a digital value of 1. Buffer device 120 outputs a digital signal 180 with a digital value of 1. Inverter device 125 outputs a digital signal 182 with a digital value of 1.

The Miller effect coupling capacitance interference is represented by a coupling capacitance of Cc. A value of 0Cc translates to signal paths transmitting in the same direction. A value of 1Cc translates to one signal path transmitting against a shielded line. A value of 2Cc translates to a worst case scenario of signal paths transmitting in opposite directions. In this example, coupling capacitance between signal paths is represented by capacitors 140, 142, 144, 146, 148, 150, 152, and 154. In this particular example, with the transmitted digital values described, the capacitance values due to Miller effect coupling capacitance is as follows. Capacitor 140 has a value of 2Cc. Capacitor 142 has a value of 2Cc. Capacitor 144 has a value of 0Cc. Capacitor 146 has a value of 0Cc. Capacitor 148 has a value of 2Cc. Capacitor 150 has a value of 2Cc. Capacitor 152 has a value of 0Cc. Capacitor 154 has a value of 0Cc.

By selective placement of inverter and buffer devices along signal paths, certainty exists that at least one half of transmission results in 0Cc Miller effect coupling capacitance, particular to this example, along lengths 132 and 136. For lengths 130 and 134, Miller effect coupling capacitance is an expected 2Cc value which can be addressed by known methods of compensation such as increasing signal strength.

The invention not only addresses issues regarding propagation delays due to the Miller effect, but addresses problems associated with minimum time (mintime) violations where transmission must occur at a specific instance of time; specifically a specific delay may be required. For mintime violation considerations, the worst scenario involves all signals changing or switching in the same direction which translates to a Miller effect coupling capacitance of 0Cc, therefore this leads to a fast switching signal that violates mintime requirements. Providing buffers and inverters along the paths provides for half of the signals to transition opposite one another. The net effect is to have a Miller effect coupling capacitance that of 1Cc for the entire path.

Although the present invention has been described in connection with several embodiments, the invention is not intended to be limited to the specific forms set forth herein, but on the contrary, it is intended to cover such alternatives, modifications, and equivalents as can be reasonably included within the scope of the invention as defined by the appended claims.

For example, buffer devices and inverter devices that store and invert signal can include not only metal oxide semiconductor stage devices with RC time constants, but can also include similar devices that invert, delay, and store signals. Other buffer and inverter devices can include firmware and/or software based devices.

What is claimed is:

1. A method of minimizing coupling capacitance interference between a first signal path and a second signal path in an elecctrical system comprising:
transmitting a first digital signal along the first signal path;
transmitting a second digital signal along the second signal path wherein the second digital signal has a value opposite a value of the first digital signal;
inverting the value of the first digital signal along the first signal path to match the value of second digital signal; and
re-inverting the first digital signal along the first signal path at a final destination of the first signal path.

2. The method of minimizing coupling capacitance interference between a first signal path and a second signal path in an electrical system of claim 1 further comprising:
storing the second signal in a buffer along the second signal path.

3. The method of minimizing coupling capacitance interference between a first signal path and a second signal path in an electrical system of claim 2 wherein inverting the first digital signal takes place when storing the second signal.

4. The method of minimizing coupling capacitance interference between a first signal path and a second signal path in an electrical system of claim 1 further comprising:
repeating the first digital signal along the first path; and
repeating the second digital signal along the second path.

5. The method of minimizing coupling capacitance interference between a first signal path and a second signal path in an electrical system of claim 2 further comprising:
a first signal repeater that repeats the first digital signal after the first digital signal is inverted; and
a second signal repeater that repeats the second digital signal after the second digital signal is stored.

6. The method of minimizing coupling capacitance interference between a first signal path and a second signal path in an electrical system of claim 1 wherein
the value of the first digital signal and the value of the second digital signal are the same for at least one half of the first signal path.

7. The method of minimizing coupling capacitance interference between a first signal path and a second signal path in an electrical system of claim 2 wherein
the value of the first digital signal and the value of the second digital signal are the same for at least one half of the first signal path.

8. The method of minimizing coupling capacitance interference between a first signal path and a second signal path in an electrical system of claim 3 wherein
the value of the first digital signal and the value of the second digital signal are the same for at least one half of the first signal path.

9. The method of minimizing coupling capacitance interference between a first signal path and a second signal path in an electrical system of claim 4 wherein
the value of the first digital signal and the value of the second digital signal are the same for at least one half of the first signal path.

10. The method of minimizing coupling capacitance interference between a first signal path and a second signal path in an electrical system of claim 5 wherein
the value of the first digital signal and the value of the second digital signal are the same for at least one half of the first signal path.

11. The method of minimizing coupling capacitance interference between a first signal path and a second signal path in an electrical system of claim 6 wherein
the value of the first digital signal and the value of the second digital signal are the same for at least one half of the first signal path.

12. An electrical transmission circuit comprised of:
a sending device transmitting a first digital signal having a value along a first signal path;
a second device transmitting a second digital signal having a value opposite the value of the first digital signal along a second signal path;
an inverter device that inverts the value of the first digital signal to match the value of the second digital signal; and
a receiving device that receives the first digital signal and the second digital signal wherein the receiving device inverts the value of the first digital signal.

13. The electrical transmission circuit of claim 12 further comprised of:
a buffer device along the second signal path that stores the value of the second digital signal.

14. The electrical transmission circuit of claim 13 wherein the inverter is placed opposite the buffer device.

15. The electrical transmission circuit of claim 12 further comprised of:
a first repeater device that repeats the first digital signal along the first signal path; and
a second repeater device that repeats the second digital signal along the second signal path.

16. The electrical transmission circuit of claim 13 further comprised of:
a first repeater device that repeats the first digital signal after the first digital signal is inverted; and
a second repeater devices that repeats the second digital signal after the second digital signal is stored.

17. The electrical transmission circuit of claim 12 wherein the value of the first digital signal and the value of the second digital signal are the same for at least one half of the first signal path.

18. The electrical transmission circuit of claim 13 wherein the value of the first digital signal and the value of the second digital signal are the same for at least one half of the first signal path.

19. The electrical transmission circuit of claim 14 wherein the value of the first digital signal and the value of the second digital signal are the same for at least one half of the first signal path.

20. The electrical transmission circuit of claim 15 wherein the value of the first digital signal and the value of the second digital signal are the same for at least one half of the first signal path.

21. The electrical transmission circuit of claim 16 wherein the value of the first digital signal and the value of the second digital signal are the same for at least one half of the first signal path.

22. An apparatus of minimizing coupling capacitance interference between a first signal path and a second signal path in an electrical system comprised of:
means for transmitting a first digital signal along the first signal path;
means for transmitting a second digital signal along the second signal path wherein the second digital signal has a value opposite a value of the first digital signal;
means for inverting the value of the first digital signal along the first signal path to match the value of second digital signal; and
means for re-inverting the first digital signal along the first signal path at a final destination of the first signal path.

23. The apparatus of minimizing coupling capacitance interference between a first signal path and a second signal path in an electrical system of claim 22 further comprised of:
means for storing the second digital signal in a buffer along the second signal path.

24. The apparatus of minimizing coupling capacitance interference between a first signal path and a second signal path in an electrical system of claim 23 wherein the means for inverting the first digital signal takes place when storing the second digital signal.

25. The apparatus of minimizing coupling capacitance interference between a first signal path and a second signal path in an electrical system of claim 22 further comprised of:
means for repeating the first digital signal; and
means for repeating the second digital signal.

26. The apparatus of minimizing coupling capacitance interference between a first signal path and a second signal path in an electrical system of claim 23 further comprised of:
means for repeating the first digital signal after inverting the first digital signal; and
means for repeating the second digital signal after storing the second digital signal.

27. The apparatus of minimizing coupling capacitance interference between a first signal path and a second signal path in an electrical system of claim 22 wherein the value of the first digital signal and the value of the second digital signal are the same for at least one half of the first signal path.

28. The apparatus of minimizing coupling capacitance interference between a first signal path and a second signal path in an electrical system of claim 23 wherein the value of the first digital signal and the value of the second digital signal are the same for at least one half of the first signal path.

29. The apparatus of minimizing coupling capacitance interference between a first signal path and a second signal path in an electrical system of claim 24 wherein the value of the first digital signal and the value of the second digital signal are the same for at least one half of the first signal path.

30. The apparatus of minimizing coupling capacitance interference between a first signal path and a second signal path in an electrical system of claim 25 wherein the value of the first digital signal and the value of the second digital signal are the same for at least one half of the first signal path.

31. The apparatus of minimizing coupling capacitance interference between a first signal path and a second signal path in an electrical system of claim 26 wherein the value of the first digital signal and the value of the second digital signal are the same for at least one half of the first signal path.
